(19) United States
(12) Patent Application Publication
(10) Pub. No.: US 2026/0175268 A1
(43) Pub. Date: Jun. 25, 2026

(54) DETECTOR AND ULTRASONIC CLEANING DEVICE

(71) Applicant: KAIJO CORPORATION, Tokyo (JP)

(72) Inventors: Saiha HIROSE, Tokyo (JP); Hiroshi HASEGAWA, Tokyo (JP); Yasuhiro IMAZEKI, Tokyo (JP)

(21) Appl. No.: 18/848,784

(22) PCT Filed: Jun. 27, 2023
(86) PCT No.: PCT/JP2023/023746

§ 371 Date: Sep. 19, 2024

(51) Int. Cl. B08B 3/12; G01H 3/00

(52) U.S. Cl. CPC B08B 3/12; G01H 3/00; B06B 2201/71

(57) ABSTRACT

To provide a detector and an ultrasonic cleaning device capable of determining whether a working state of each structural component of the ultrasonic cleaning device is normal or abnormal, when there is abnormality such as having small output from a sound pressure sensor of a detector. Thus, the detector that detects the sound pressure of a cleaning liquid includes: a support body that is immersed at least partially in the cleaning liquid; and a plurality of sound pressure sensors having a same detection characteristic with each other, the sound pressure sensors being placed in a non-wetted part of the support body at equal intervals about a central axis of the support body. Vibration caused by the ultrasonic wave propagated through the support body is detected as a sound pressure value by each of the plurality of sound pressure sensors.

### CROSS REFERENCE TO RELATED APPLICATIONS

This application is a 371 U.S. National Phase of International Application No. PCT/JP2023/023746, filed on Jun. 27, 2023. The entire disclosure of the above application is incorporated herein by reference.

### BACKGROUND OF THE INVENTION

### 1. Field of the Invention

The present invention relates to a detector used in an ultrasonic cleaning device and to an ultrasonic cleaning device provided with the detector.

### 2. Description of the Related Art

For a device used for performing ultrasonic cleaning, there is a proposed configuration that includes a detection device or a sensor capable of detecting sound pressure in order to detect the sound pressure of a liquid in a cleaning tank or a treatment tank where ultrasonic waves are applied. For example, a sound pressure detection device disclosed in Japanese Patent Application Laid-open No. 2001-21412 is configured with a probe and a monitor, and the probe includes a rod-shaped sensitive piece, a grip part for supporting a rear end part of the sensitive piece, and a sound pressure sensor adhered to a rear end face of the sensitive piece inside the grip part. A piezoelectric element is used as the sound pressure sensor. The adhered part of the sound pressure sensor and the peripheral part thereof are fixed on the inner side of the tip part of the grip part by pushing in a holder into an outer peripheral face of the grip part so as to cover the rear end part of the sensitive piece and the tip part of the grip part from the outer side.

However, the sound pressure detection device disclosed in Japanese Patent Application Laid-open No. 2001-21412 when used over a long period of time may have defects such as separation and floating of the sound pressure sensor from the sensitive piece, loosening and damaging of the holder, and deterioration of the sound pressure sensor itself, which may cause issues such as having a smaller amplitude in the detection signals than it is supposed to be. In the meantime, when the amplitude of detection signals becomes smaller, it may be a case where, in addition to the sound pressure sensor, a transducer or an oscillator giving ultrasonic waves to the treatment tank has a defect, a case where the treatment tank is in a no-liquid working state because the liquid in the treatment tank is reduced. This makes it difficult to determine whether the working state of each structural component is normal or abnormal.

The present invention is designed in view of such circumstances, and an object thereof is to provide a detector and an ultrasonic cleaning device capable of determining whether the working state of each structural component of the ultrasonic cleaning device is normal or abnormal when there is abnormality such as having small output from a sound pressure sensor of a detector that detects the sound pressure of a liquid in a cleaning tank of the ultrasonic cleaning device, and capable of determining whether the operation state of the ultrasonic cleaning device is normal or abnormal depending on whether the working states of all of each of the structural components are normal or there is abnormality in the working state of at least one component. Furthermore, another object of the present invention is to provide a detector and an ultrasonic cleaning device capable of determining whether there is abnormality in a sound pressure sensor. Still another object of the present invention is to provide a detector and an ultrasonic cleaning device which, when there is abnormality generated in the output from the detector, are capable of determining whether a sound pressure sensor, a cleaning tank, a transducer that irradiates ultrasonic waves to the cleaning tank, or an oscillator has abnormality.

### SUMMARY OF THE INVENTION

In order to overcome such issues, a detector according to the present invention is a detector detecting a sound pressure of a cleaning liquid in an ultrasonic cleaning device that includes: a cleaning tank with the cleaning liquid; a transducer configured to irradiate an ultrasonic wave to the cleaning tank; and an oscillator configured to apply a drive signal to the transducer for generating the ultrasonic wave, the detector including: a support body that is immersed at least partially in the cleaning liquid; and a plurality of sound pressure sensors having a same detection characteristic with each other, the sound pressure sensors being placed in a non-wetted part of the support body at equal intervals about a central axis of the support body, in which vibration caused by the ultrasonic wave propagated through the support body is detected as a sound pressure value by each of the plurality of sound pressure sensors.

An ultrasonic cleaning device according to the present invention is an ultrasonic cleaning device including: a cleaning tank with a cleaning liquid; a transducer configured to irradiate an ultrasonic wave to the cleaning tank; an oscillator configured to apply a drive signal to the transducer for generating the ultrasonic wave; a detector including: a support body that is immersed in the cleaning liquid at least in a tip end part; and a plurality of sound pressure sensors having a same detection characteristic with each other, the sound pressure sensors being placed in a rear end part of the support body at equal intervals about a central axis of the support body, in which vibration caused by the ultrasonic wave propagated through the support body is detected as a sound pressure value by each of the plurality of sound pressure sensors; and a controller where the detector is connected, in which the controller determines whether an operation state of the ultrasonic cleaning device is normal or abnormal based on a detection result of the detector.

In the ultrasonic cleaning device according to the present invention, the controller includes: a determiner configured to determine whether a working state of the detector is normal or abnormal based on the sound pressure values detected by each of the plurality of sound pressure sensors; and a display capable of displaying the detection result acquired by the detector, and the determiner sets the plurality of sound pressure sensors as a single lower sound pressure sensor with the sound pressure value that is the smallest and as a higher sound pressure sensor except the lower sound pressure sensor, and determines whether the working state of the detector is normal or abnormal based on a lower sound pressure value detected by the lower sound pressure sensor and a reference sound pressure value that corresponds to a higher sound pressure value detected by the higher sound pressure sensor.

In the ultrasonic cleaning device according to the present invention, the determiner determines whether the working state of the detector is normal or abnormal based on a result of comparison between a product of the reference sound pressure value and a prescribed threshold and the lower sound pressure value.

In the ultrasonic cleaning device according to the present invention, when there are three or more sensors as the plurality of sound pressure sensors, the reference sound pressure value is an average value of the higher sound pressure values of two higher sound pressure sensors with greater sound pressure values among the higher sound pressure sensors.

In the ultrasonic cleaning device according to the present invention, the determiner determines whether a working state of the oscillator is normal or abnormal based on whether there is output of the drive signal from the oscillator.

In the ultrasonic cleaning device according to the present invention, the determiner determines whether a working state of the transducer is normal or abnormal based on a result of comparison between an initial sound pressure value defined in advance and the reference sound pressure value.

In the ultrasonic cleaning device according to the present invention, when there are two sensors as the plurality of sound pressure sensors, the reference sound pressure value is the higher sound pressure value that is detected by a single higher sound pressure sensor.

The ultrasonic cleaning device according to the present invention includes a controller configured to output a stop signal for stopping an operation of the ultrasonic cleaning device, when determined by the determiner that the working state of the detector is abnormal.

With the present invention, it is possible to determine whether the working state of each structural component of the ultrasonic cleaning device is normal or abnormal when there is abnormality such as having small output from the sound pressure sensor of the detector that detects the sound pressure of the liquid in the cleaning tank of the ultrasonic cleaning device. Furthermore, it is possible to determine whether there is abnormality in the sound pressure sensor. Moreover, when there is abnormality generated in the output from the detector, it is also possible to determine whether the sound pressure sensor, the cleaning tank, the transducer that irradiates ultrasonic waves to the cleaning tank, or the oscillator has abnormality.

### BRIEF DESCRIPTION OF THE DRAWINGS

FIGS. 1A and 1B are side views illustrating a configuration of a support body of a detector according to a first embodiment, and FIG. 1C is a plan view of the support body;

FIGS. 2A and 2B are side views illustrating a configuration of the detector according g to the first embodiment, FIG. 2C is a diagram illustrating a state where wires are fixed to the detector illustrated in FIG. 2A, and FIG. 2D is a plan view of the detector;

FIGS. 3A and 3B are diagrams including block diagrams illustrating a configuration of an ultrasonic cleaning device according to the first embodiment;

FIG. 4 is a flowchart indicating a procedure of a normal/abnormal determination method according to the first embodiment;

FIG. 5A is a side view illustrating a configuration of a support body according to a first modification example, FIG. 5B is a side view illustrating a configuration of a detector according to the first modification example, FIG. 5C is a plan view of the support body illustrated in FIG. 5A, and FIG. 5D is a plan view of the detector illustrated in FIG. 5B;

FIG. 6A is a side view illustrating a configuration of a support body according to a second modification example, FIG. 6B is a side view illustrating a configuration of a detector according to the second modification example, FIG. 6C is a plan view of the support body illustrated in FIG. 6A, and FIG. 6D is a plan view of the detector illustrated in FIG. 6B;

FIG. 7A is a plan view illustrating placement of a support body and sound pressure sensors according to a third modification example, FIG. 7B is a side view illustrating a configuration of a detector according to the third modification example, FIG. 7C is a plan view illustrating placement of a support body and sound pressure sensors according to a fourth modification example, and FIG. 7D is a side view illustrating a configuration of a detector according to the fourth modification example;

FIG. 8A is a plan view illustrating placement of a support body and sound pressure sensors according to a fifth modification example, FIG. 8B is a side view illustrating a configuration of a detector according to the fifth modification example, FIG. 8C is a plan view illustrating placement of a support body and sound pressure sensors according to a sixth modification example, FIG. 8D is a side view illustrating a configuration of a detector according to the sixth modification example;

FIG. 9 is a diagram illustrating a state where the detector according to the fifth modification example is fixed to a cleaning tank;

FIGS. 10A and 10B are diagrams including block diagrams illustrating a configuration of an ultrasonic cleaning device according to a second embodiment; and

FIG. 11 is a flowchart indicating a procedure of a normal/abnormal determination method according to the second embodiment.

### DETAILED DESCRIPTION

### First Embodiment

A detector and an ultrasonic cleaning device according to a first embodiment of the present invention will be described in detail with reference to the accompanying drawings.

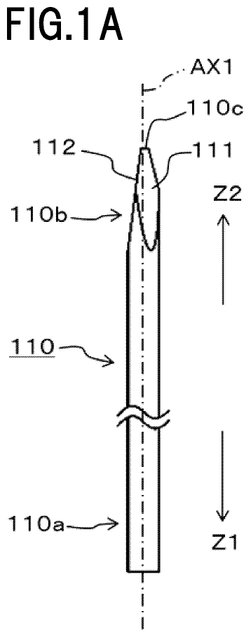

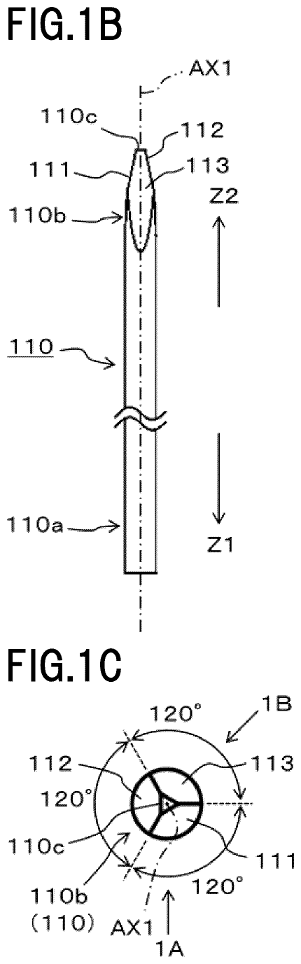

FIGS. 1A and 1B are side views illustrating the configuration of a support body 110 of a detector 10 according to the first embodiment, and FIG. 1C is a plan view of the support body 110. FIG. 1A is a diagram viewed from the direction of 1A in FIG. 1C, and FIG. 1B is a diagram viewed from the direction of 1B in FIG. 1C.

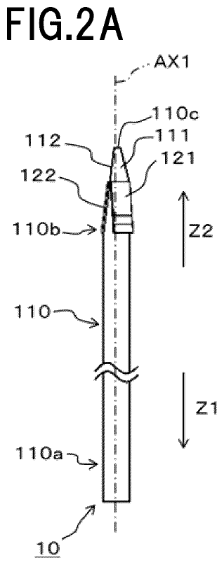

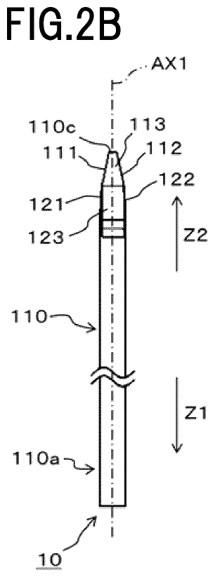

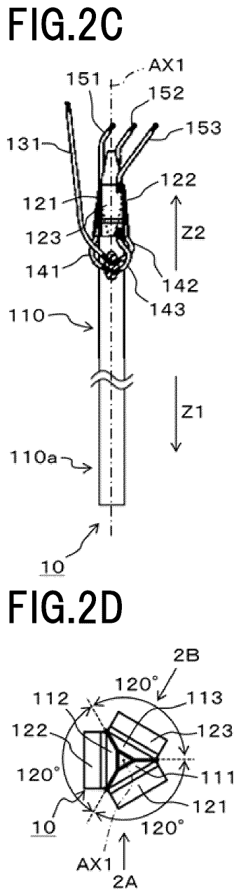

FIGS. 2A and 2B are side views illustrating the configuration of the detector 10 according to the first embodiment, FIG. 2C is a diagram illustrating a state where wires are attached and fixed to the detector 10 illustrated in FIG. 2A, and FIG. 2D is a plan view of the detector 10. FIG. 2A is a diagram viewed from the direction of 2A in FIG. 1C, and FIG. 2B is a diagram viewed from the direction of 2B in FIG. 2C.

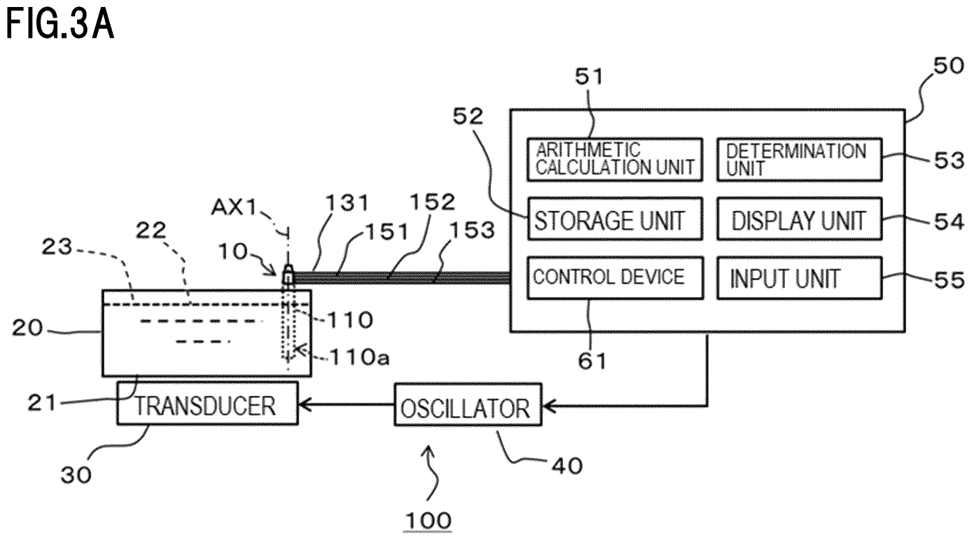

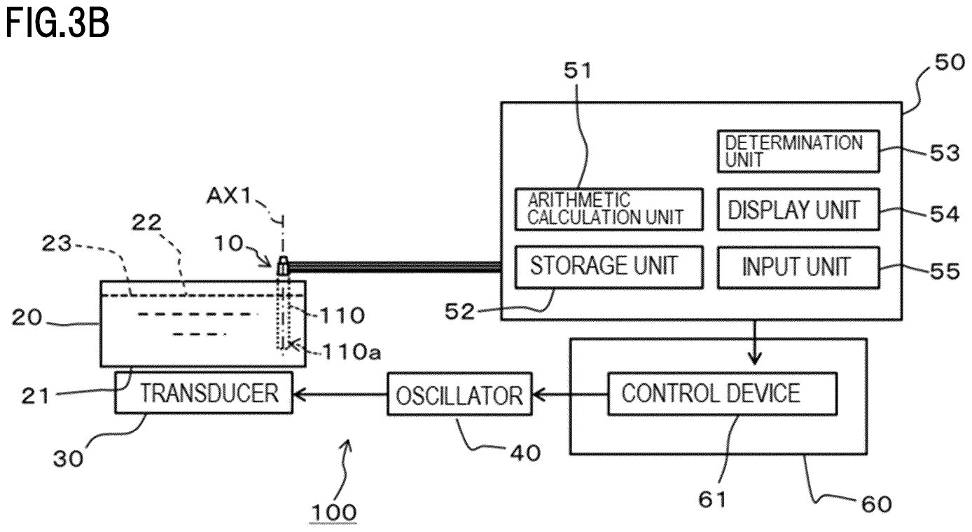

FIGS. 3A and 3B are diagrams including block diagrams illustrating the configuration of an ultrasonic cleaning device 100 according to the first embodiment.

As illustrated in FIG. 3A, the ultrasonic cleaning device 100 has a configuration that includes the detector 10 (FIGS. 2A, 2B, and 2C). As illustrated in FIG. 3B, it is also possible to have a configuration in which an external device 60 having a control device 61 is added to the configuration illustrated in FIG. 3A.

The configuration of each structural component will be described hereinafter.

### Detector 10

The detector 10 has the configuration in which, as illustrated in FIGS. 2A, 2B, 2C, and 2D, three piezoelectric elements are disposed as sound pressure sensors on the support body 110 illustrated in FIGS. 1A, 1B, and 1C.

The support body 110 is a rod-shaped member that is capable of propagating vibration caused by the sound pressure of a cleaning liquid 23, when immersed in a cleaning tank 20 (FIGS. 3A and 3B). As such a rod-shaped member, there is a member molded using stainless steel or quartz, for example, and the support body 110 has a columnar shape with a central axis AX1. Changes in the sound pressure of the cleaning liquid 23 are caused by the ultrasonic waves applied from a transducer 30 (see FIGS. 3A and 3B) to the cleaning liquid 23 in the cleaning tank 20, and vibrations propagated via the support body 110 correspond to the sound pressure of the ultrasonic waves applied from the transducer 30.

As illustrated in FIGS. 1A and 1B, the support body 110 includes a tip end part 110a and a rear end part 110b in a Z1-Z2 direction along the central axis AX1. As illustrated in FIGS. 3A and 3B, the tip end part 110a side of the support body 110 is immersed in the cleaning liquid 23, and the rear end part 110b side is placed on the higher side than a liquid surface 22 of the cleaning liquid 23. In other words, the tip end part 110a that is a part of the support body 110 is immersed in the cleaning liquid 23. Sound pressure sensors 121, 122, and 123 are placed at positions higher than the liquid surface 22 of the cleaning liquid 23 when it is at the highest water level. Thus, the sound pressure sensors 121, 122, and 123 are placed at the positions not immersed in the cleaning liquid 23 regardless of the changes in the liquid surface of the cleaning liquid 23. That is, the rear end part 110b as a non-wetted part is always placed on a higher side than the liquid surface 22 of the cleaning liquid 23. This makes it possible to prevent changes in the characteristics of the sound pressure sensors 121, 122, 123, deterioration thereof, progression of separation, and the like caused by being immersed in the cleaning liquid 23 inside the cleaning tank 20.

As illustrated in FIGS. 1A, 1B, and 1C, in the rear end part 110b of the support body 110, three sloping faces 111, 112, and 113 are formed symmetrically with respect to each other about the central axis AX1. In other words, the sloping faces 111, 112, and 113 are provided at equal angular intervals of 120 degrees about the central axis AX1. The sloping faces 111, 112, and 113 have the same or substantially same planar shape, and are provided in a same range in the Z1-Z2 direction in the form of slopes that approaches the central axis AX1 as going toward a rear end face 110c on the rearmost side of the rear end part 110b.

As illustrated in FIGS. 2A, 2B, 2C, and 2D, the three sound pressure sensors 121, 122, and 123 are fixed to the three sloping faces 111, 112, and 113, respectively. An adhesive is used for the fixation, and an epoxy adhesive is used as the adhesive, for example. The sound pressure sensors 121, 122, and 123 are plate-shaped piezoelectric elements having the same shape, same deformation mode, and same detection characteristic with each other. There is no limit set for the deformation mode. However, in a case of using piezoelectric elements with a deformation mode to change the shape in the thickness direction, for example, the bottom faces thereof are bonded and fixed to the corresponding sloping faces (sloping faces 111, 112, and 113). The three sound pressure sensors 121, 122, and 123 are placed at positions where the corner parts of the neighboring sound pressure sensors on the Z2 side (rear end side) of the Z1-Z2 direction are adjacent to each other. As illustrated in FIG. 2D, the sound pressure sensors 121, 122, and 123 are provided at equal angular intervals of 120 degrees about the central axis AX1. By placing the sound pressure sensors 121, 122, and 123 at positions where the corner parts of the neighboring sound pressure sensors on the Z2 side (rear end side) of the Z1-Z2 direction are adjacent to each other, the sloping faces 111, 112, and 113 on the rear end face 110c side of the rear end part 110b of the support body 110 are exposed without being covered by the sound pressure sensors 121, 122, and 123.

The sound pressure sensors 121, 122, and 123 are provided on the sloping faces 111, 112, and 113, respectively, so that the area for fixing the pressure sensors can be secured wider compared to the configuration without the sloping faces. Furthermore, vibrations along the central axis AX1 of the support body 110 and vibrations at angles with respect to the central axis AX1 can all be detected with certain accuracy. This allows higher freedom of choice in piezoelectric elements as the sound pressure detection elements. Note here that the tilt angle of the sloping faces 111, 112, and 113 with respect to the central axis AX1 can be set arbitrarily in accordance with the size and the like of the sound pressure sensors 121, 122, and 123.

As illustrated in FIG. 2C and FIGS. 3A, 3B, one ends of signal lines 131, 151, 152, and 153 are each connected to the detector 10, with the other ends thereof being electrically connected to a main body unit 50 as control means. Insulation coated electric wires are used for the signal lines 131, 151, 152, and 153. The first signal line 131 is soldered to the support body 110, and three connection lines 141, 142, and 143 electrically connected thereto are connected to the negative electrodes of the sound pressure sensors 121, 122, and 123, respectively. The three second signal lines 151, 152, and 153 are connected to the positive electrodes of the sound pressure sensors 121, 122, and 123, respectively. With such wiring, the pressure applied to each of the sound pressure sensors 121, 122, and 123 by the vibration propagated through the support body 110 is converted to a voltage, and the voltage is detected by the main body unit 50 as a sound pressure value in the cleaning liquid 23 inside the cleaning tank 20.

### Ultrasonic Cleaning Device 100

As illustrated in FIG. 3A, the ultrasonic cleaning device 100 includes the detector 10, the cleaning tank 20, the transducer 30, an oscillator 40, and the main body unit 50. It is also possible to have a configuration in which the external device 60 is added to the ultrasonic cleaning device 100.

The cleaning liquid 23 for cleaning is filled in the cleaning tank 20. The detector 10 is fixed to the cleaning tank 20 or to a fixture (not illustrated) outside the cleaning tank 20 such that the central axis AX1 of the support body 110 is set along the vertical direction, that the tip end part 110a is immersed in the cleaning liquid 23, and that at least the sound pressure sensors 121, 122, 123 are positioned to be higher than the liquid surface 22 on the rear end part 110b side. As for the cleaning liquid 23, new cleaning liquid 23 is supplied into the cleaning tank 20 by a pump, a solenoid valve (not shown), or the like in a prescribed amount in accordance with the expected cleaning progress, and dirty cleaning liquid 23 is discharged to the outside by a pump, a solenoid valve (not shown), or the like.

Thereby, the sound pressure sensors 121, 122, and 123 are attached and fixed to the detector 10 as a single rod-shaped member, and the same kind of signals are acquired from each of the sound pressure sensors 121, 122, and 123 as the signals generated from the sound pressure sensors 121, 122, and 123. The inventors of the present invention has come to complete the present invention by finding that it is possible to determine whether the working state of which of the sound pressure sensors 121, 122, 123, the cleaning tank 20, the transducer 30 that irradiates ultrasonic waves to the cleaning tank 20, and the oscillator 40 is abnormal when there is abnormality in the output from the detector 10 by comparing the same kind of acquired signals. In short, the signals generated from the sound pressure sensors 121, 122, and 123 are the same kind of signals, so that the sound pressure values acquired from the generated signals can provide only the intensity of the signals. Thus, it is difficult with such processing alone to determine whether the working states of each of the structural components and the like of the cleaning device according to the present invention are normal or abnormal. Therefore, the inventors of the present invention have come to complete the present invention by comparing the signals of the same kind, that is, the signals having the same detection characteristic generated from the sound pressure sensors 121, 122, and 123. Details thereof will be described later.

In addition, the sound pressure sensors 121, 122, and 123 are provided by being attached and fixed on the rear end part 110b side of the detector 10 as a single rod-shaped member. Thus, the sound pressure sensors 121, 122, and 123 are placed in the vicinity of the rear end part 110b side of the detector 10 as a single rod-shaped member, so that variation and the like in the signals generated from each of the sound pressure sensors 121, 122, and 123 can be suppressed, thereby increasing the accuracy of the signals to be acquired.

The transducer 30 is attached and fixed to a bottom face 21 of the cleaning tank 20. As for the type of the transducer 30, any types can be used in accordance with the specifications of cleaning to be performed by the ultrasonic cleaning device 100. The transducer 30 vibrates ultrasonically according to drive signals given from the oscillator 40. The ultrasonic waves are irradiated to the cleaning tank 20 and applied to the cleaning liquid 23 in the cleaning tank 20. The sound pressure in the cleaning liquid 23 fluctuates according to the vibration of the ultrasonic waves.

The main body unit 50 includes an arithmetic calculation unit 51, a storage unit 52, a determination unit 53, a display unit 54, an input unit 55, and the control device 61. The arithmetic calculation unit 51 calculates the sound pressure values that are detected by each of the sound pressure sensors 121, 122, and 123 based on the voltages between the first signal line 131 and each of the three second signals 151, 152, and 153. As for the calculation of the sound pressure values, the voltage values saved in the storage unit 52 in advance are displayed as the sound pressure levels. Note here that a conversion table and a conversion formula based on the correlation between the voltage values and the sound pressure values are saved in the storage unit 52, and the arithmetic calculation unit 51 calculates the sound pressure value from the voltage value based on the conversion table and the conversion formula.

The arithmetic calculation unit 51 saves the calculated sound pressure values in the storage unit 52 in association with the names of the corresponding sound pressure sensors (the sound pressure sensors 121, 122, 123). Furthermore, the arithmetic calculation unit 51 calculates an average value Ave (reference sound pressure value) of the two higher sound pressure values, that is, the two larger sound pressure values (higher sound pressure values), among the sound pressure values detected by the three sound pressure sensors 121, 122, and 123, and saves it in the storage unit 52 by associating with the names of the two sound pressure sensors (higher sound pressure sensors) detecting the sound pressure values. Furthermore, a lowest sound pressure value Min, that is, the smallest sound pressure value (lower sound pressure value) and the name of the sound pressure sensor (lower sound pressure sensor) detecting the sound pressure value are saved in the storage unit 52 in combination. Note here that the higher sound pressure sensors are the two sound pressure sensors except the lower sound pressure sensor among the three sound pressure sensors 121, 122, and 123.

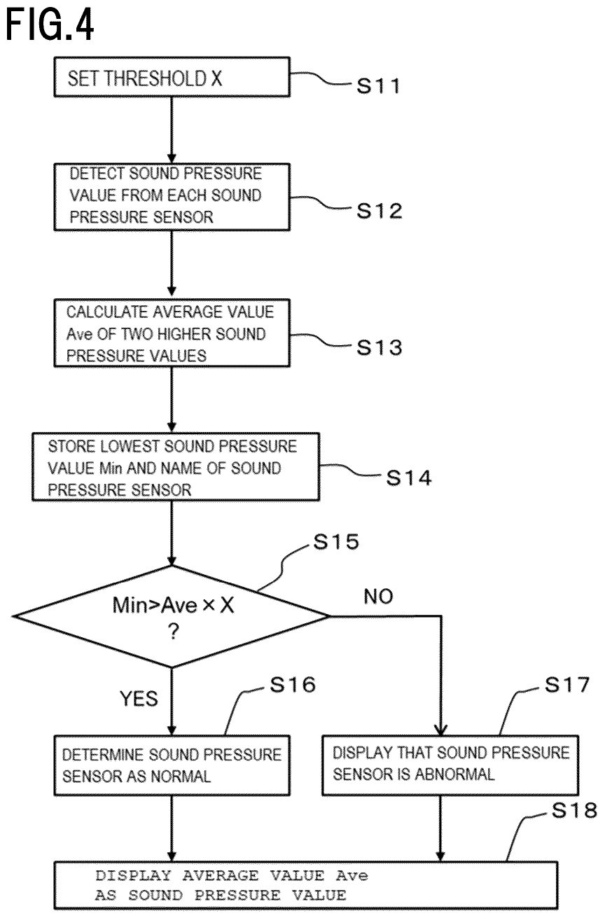

The sound pressure values calculated by the arithmetic calculation unit 51 are output to the determination unit 53. The determination unit 53 performs a comparison operation on the product of the average value Ave and a prescribed threshold X and the lowest sound pressure value Min and, based on the comparison result, determines whether the working states of the sound pressure sensors 121, 122, 123 are normal or abnormal, that is, determines whether there is abnormality in the working states. The determination result is saved in the storage unit 52, and displayed on the display unit 54 in a prescribed format in the processing illustrated in FIG. 4. The threshold X is input by an operation of the input unit 55, and saved in the storage unit 52. The main body unit 50 (determination unit 53) as the control means determines that the operation state of the ultrasonic cleaning device 100 is normal when the working states of all sound pressure sensors 121, 122, 123 are normal, and determines that the operation state of the ultrasonic cleaning device 100 is abnormal when there is abnormality found in the working state of any of those sensors.

The control device 61 receives the determination result made by the determination unit 53, generates a control signal for the oscillator 40 based on the determination result, and outputs it to the oscillator 40. An example of the control signal may be a control signal for causing the oscillator 40 to stop sending the drive signal to the transducer 30 when determined in the determination result made by the determination unit 53 that there is abnormality in the working state of any of the sound pressure sensors 121, 122, and 123.

As illustrated in FIG. 3B, the external device 60 includes a control device 61 that is connected to each of the main body unit 50 and the oscillator 40 of the ultrasonic cleaning device 100. The control device 61 has the same function as the control device 61 provided in the main body unit 51 in the configuration illustrated in FIG. 3A.

FIG. 4 is a flowchart indicating the procedure for determining whether the operation state of the ultrasonic cleaning device according to the first embodiment is normal or abnormal, that is, for determining whether the working states of each of the structural components are normal or abnormal. Hereinafter, determination on normal/abnormal states in the first embodiment will be described with reference to FIG. 4.

Before starting to drive the transducer 30, the input unit 55 is operated to set and store the threshold X in the storage unit 52 in advance (step S11 in FIG. 4). The threshold X is set arbitrarily in accordance with the characteristic (frequency and the like) of the ultrasonic waves generated by the transducer 30, the temperature, liquid depth, and amount of the cleaning liquid 23, placed height of the sound pressure sensors 121, 122, 123 in the cleaning tank 20, the characteristics of the sound pressure sensors 121, 122, 123, the vibration characteristic of the support body 110, placement of the detector 10 in the cleaning tank 20, and the shape, type, and the like of the cleaning target.

The sound pressure values of the cleaning tank 20 and the like fluctuate at all times because of the environment and the like, so that the threshold X is set to prevent false detection caused by such fluctuations.

Then, output of the drive signal from the oscillator 40 to the transducer 30 is started, and the transducer 30 irradiates ultrasonic waves to the cleaning tank 20. At this time, a sound pressure according to the irradiated ultrasonic waves is generated in the cleaning liquid 23 inside the cleaning tank 20. Vibration corresponding to the sound pressure occurs in the part of the support body 110 of the detector 10 immersed in the cleaning liquid 23, and the vibration is propagated to the rear end part 110b side. The vibration is converted to the voltages proportional to deformation in the sound pressure sensors 121, 122, and 123 provided on the sloping faces 111, 112, and 113 of the rear end part 110b, the voltages are converted to the sound pressure values in the arithmetic calculation unit 51, and the sound pressure values in each of the sound pressure sensors 121, 122, and 123 are detected thereby (step S12). The detected sound pressure values are saved in the storage unit 52 in association with the names of the sound pressure sensors 121, 122, and 123.

The arithmetic calculation unit 51 compares the three sound pressure values detected at the same timing by each of the three sound pressure sensors 121, 122, and 123, and determines the order according to the magnitude of the sound pressure values. Furthermore, the arithmetic calculation unit 51 calculates the average value Ave of the two higher sound pressure values, and saves it in the storage unit 52 along with the names that specify the corresponding sound pressure sensors (step S13). The arithmetic calculation unit 51 also saves the lowest sound pressure value Min in the storage unit 52 along with the name that specifies the corresponding sound pressure sensor (step S14). In the saving operations performed in steps S13 and S14 described above, the time thereof is also saved in an associated manner.

Note that the lowest sound pressure value Min may be saved at the time of determining the order.

Furthermore, when the sound pressure values of the three sound pressure sensors 121, 122, and 123 are the same, two arbitrary values thereof are used as the two higher sound pressure values to calculate the average value Ave (step S13), and the remaining one is saved as the lowest sound pressure value Min in the storage unit 52 (step S14).

The average value Ave and the lowest sound pressure value Min are given to the determination unit 53, and the determination unit 53 reads out the threshold X from the storage unit 52 to calculate the product of the average value Ave and the threshold X, and compares it with the sound pressure value Min (step S15).

When the sound pressure value Min is greater than the product of the average value Ave and the threshold X (YES at step S15), the determination unit 53 determines that the working state of the sound pressure sensor corresponding to the sound pressure value Min is normal (step S16). At this time, the main body unit 50 as the control means determines that the operation state of the ultrasonic cleaning device 100 is normal.

In the meantime, when the sound pressure value Min is smaller than or equivalent to the product of the average value Ave and the threshold X (NO at step S15), the determination unit 53 determines that the working state of the sound pressure sensor corresponding to the sound pressure value Min is abnormal. When determined to be abnormal, the determination unit 53 displays on the display unit 54 that there is abnormality in the working state of the sound pressure sensor (step S17). Thereafter, regardless of whether there is abnormality, the determination unit 53 after steps S16 and S17 displays the average value Ave as the sound pressure value on the display unit 54 (step S18). At this time, the main body unit 50 as the control means determines that the operation state of the ultrasonic cleaning device 100 is abnormal.

The threshold X is preferable to be set to a numerical value that is greater than 0 and smaller than 1, when used for determining whether the sound pressure value Min is greater than the product of the average value Ave and the threshold X as in step S15 described above. Herein, when the threshold X is set to be in a larger value (for example, 0.7 or greater), abnormality in the working state of the sound pressure sensors can be determined at an early stage, thereby making it possible to prevent the cleaning target from being affected by flaking and the like. When the threshold X is set to be in a smaller value (for example, 0.5 or smaller), it is possible to prevent changes in the sound pressure values caused due to the cleaning condition and the like from being mistakenly determined as abnormality in the working state of the sound pressure sensor.

As described above, the average value of the two higher sound pressure values is calculated, and whether the working state is normal or abnormal is determined based thereupon. The average value of the two higher values is used as the reference for determination, since the sound pressure value of the sound pressure sensor determined as abnormal is significantly low value and it is considered extremely rare that two or more sound pressure sensors among the three sound pressure sensors 121, 122, and 123 have failure simultaneously. Thus, it is possible with the present invention to improve the detection accuracy.

Whether the working state of the sound pressure sensor is normal or abnormal is determined not based on the sound pressure value itself but based on the product of the average value Ave of the sound pressure values of the higher sound pressure sensors and the threshold X. It is because the propagation state of the vibration in the cleaning tank 20 changes at all times due to the inflow/outflow of the cleaning liquid 23 and the changes corresponding to the environment such as sway on the liquid surface, for example, so that the sound pressure values to be detected fluctuate as well. Therefore, if the working state of the sound pressure sensor is normal or abnormal is determined based on the sound pressure value itself, there is a risk of having a false detection that may be caused due to slight fluctuation in the sound pressure values. On the contrary, the use of the product acquired using the threshold X makes it possible to prevent a false detection that may be caused due to minute fluctuation and also makes it easier to determine the working state of the sound pressure sensor whose sound pressure value is significantly low as abnormal.

Modification examples will be described hereinafter.

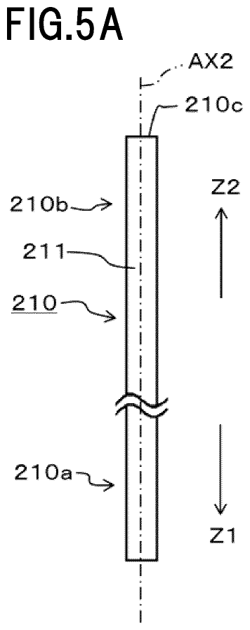

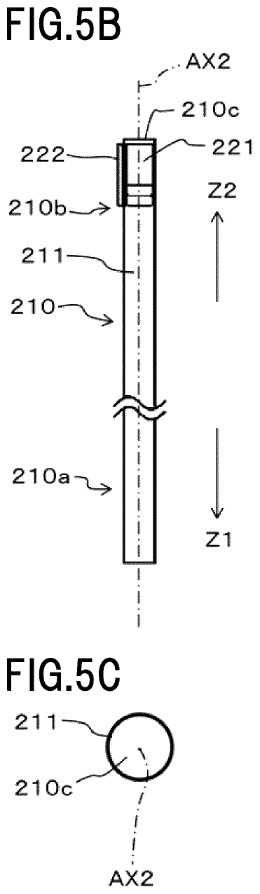

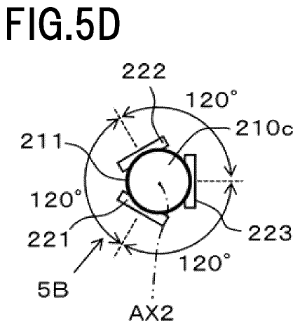

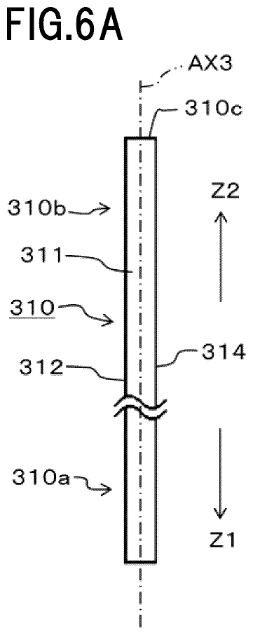

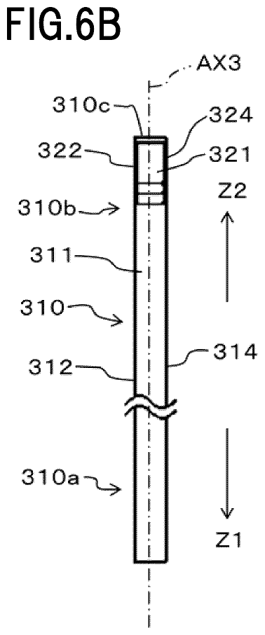

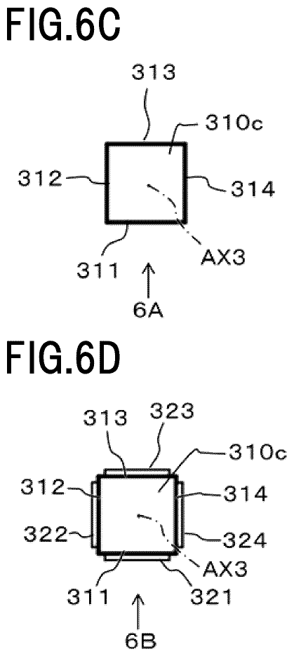

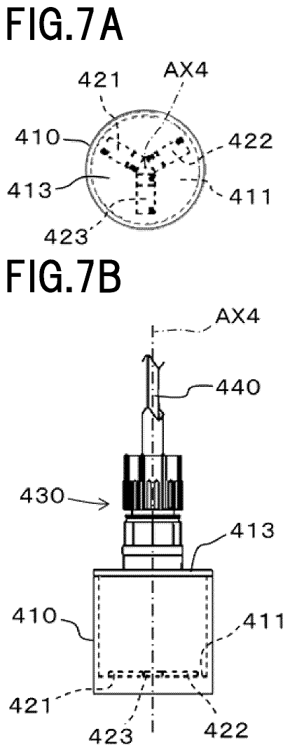

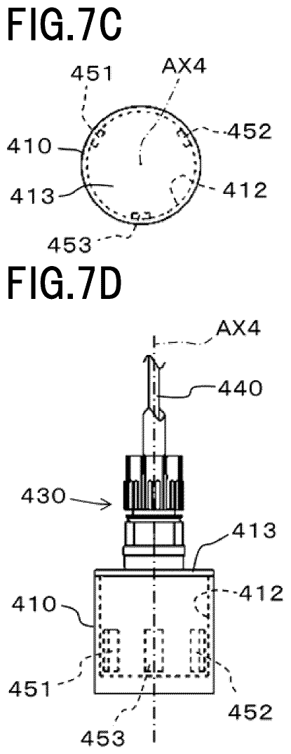

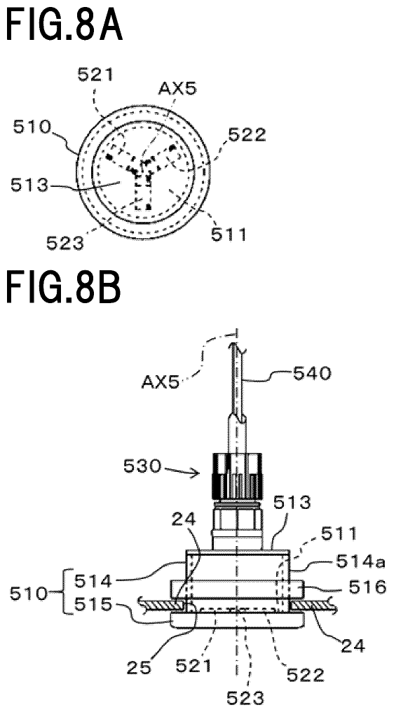

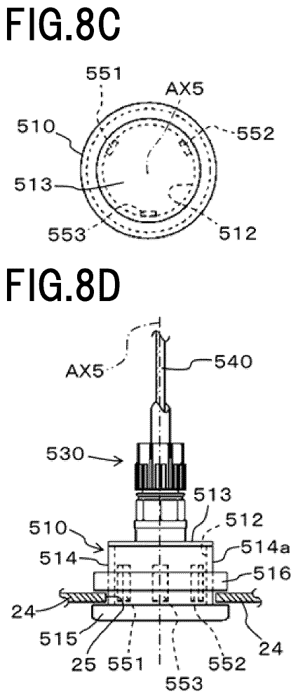

The shape of the support body used as the detector may be in any shape as long as it has a specific range, that is, a part of the support body, immersed in the cleaning liquid 23 in the cleaning tank 20 and also has sound pressure sensors placed in the non-wetted part. For example, there may be a columnar shape having no sloping face as illustrated in FIG. 5A, a prismatic shape as illustrated in FIG. 6A, a cylindrical shape as illustrated in FIGS. 7, and a cylindrical shape with flange as illustrated in FIG. 8.

### First Modification Example

FIG. 5A is a side view illustrating a configuration of a support body 210 according to a first modification example, FIG. 5B is a side view illustrating a configuration of a detector according to the first modification example, FIG. 5C is a plan view of the support body 210 illustrated in FIG. 5A, and FIG. 5D is a plan view of the detector illustrated in FIG. 5B. FIG. 5B is a diagram viewed from a direction of 5B in FIG. 5D.

The support body 210 illustrated in FIG. 5A includes a tip end part 210a and a rear end part 210b in a Z1-Z2 direction along a central axis AX2. On the support body 210, sound pressure sensors 221, 222, and 223 in the same configuration as that of the sound pressure sensors 121, 122, and 123 of the first embodiment described above are each adhered and fixed on an external peripheral face 211 of the rear end part 210b at equal angular intervals about the central axis AX2.

### Second Modification Example

FIG. 6A is a side view illustrating a configuration of a support body 310 according to a second modification example, FIG. 6B is a side view illustrating a configuration of a detector according to the second modification example, FIG. 6C is a plan view of the support body 310 illustrated in FIG. 6A, and FIG. 6D is a plan view of the detector illustrated in FIG. 6B. FIG. 6A is a diagram viewed from a direction of 6A in FIG. 6C, and FIG. 6B is a diagram viewed from a direction of 6B in FIG. 6D.

The support body 310 illustrated in FIG. 6A includes a tip end part 310a and a rear end part 310b in a Z1-Z2 direction along a central axis AX3, and has a quadrangular prism shape with four outer side faces 311, 312, 313, and 314. On the support body 310, four sound pressure sensors 321, 322, 323, and 324 in the same configuration as that of the sound pressure sensors 121, 122, and 123 of the first embodiment described above are each adhered and fixed on the four outer side faces 311, 312, 313, and 314 of the rear end part 310b. The sound pressure sensors 321, 322, 323, and 324 have the smaller width than that of the outer side faces 311, 312, 311, and 314, so that the sensors can be fixed to the support body 310 without being in contact with each other.

### Third and Fourth Modification Examples

FIG. 7A is a plan view illustrating placement of a support body 410 and sound pressure sensors 421, 422, and 423 according to a third modification example, and FIG. 7B is a side view illustrating a configuration of a detector according to the third modification example. FIG. 7C is a plan view illustrating placement of the support body 410 and sound pressure sensors 451, 452, and 453 according to a fourth modification example, and FIG. 7D is a side view illustrating a configuration of a detector according to the fourth modification example. FIGS. 7A and 7C illustrate the states where the support body 410 is closed by a lid part 413, and inside structures are illustrated with broken lines. The third modification example and the fourth modification example will be described by applying same reference numerals to the common members.

The support body 410 is a hollow columnar member with a bottom, and it is formed with a same material as that of the first embodiment.

In the third modification example illustrated in FIGS. 7A and 7B, the three sound pressure sensors 421, 422, and 423 are adhered and fixed on a bottom face 411 on the inner side of the support body 410. The sound pressure sensors 421, 422, and 423 are placed at equal angular intervals to be symmetrical with each other about a central axis AX4 of the support body 410. In other words, each of the sound pressure sensors 421, 422, and 423 is placed at equal intervals around the central axis AX4 to extend in a radial direction from the central axis AX4 side.

After having the sound pressure sensors 421, 422, and 423 placed inside, the support body 410 has the top part sealed by the disc-shaped lid part 413. This makes it possible to prevent the liquid from entering the internal space where the sound pressure sensors are placed.

A connector 430 is placed on the lid part 413, and electrically connected to each of the sound pressure sensors 421, 422, and 423. A cable 440 connected to the main body unit 50 is connected to the connector 430. Thereby, the sound pressure sensors 421, 422, 423 and the main body unit 50 are connected to each other.

In the fourth modification example illustrated in FIGS. 7C and 7D, the three sound pressure sensors 451, 452, and 453 are adhered and fixed on an inner peripheral face 412 of the support body 410. The sound pressure sensors 421, 422, and 423 are placed at equal angular intervals to be symmetrical with each other about the central axis AX4 of the support body 410. In other words, each of the sound pressure sensors 451, 452, and 453 is placed at equal intervals around the central axis AX4 to extend in the radial direction from the central axis AX4 side. The configurations regarding the lid part 413, the connector 430, and the cable 440 are the same as those of the third modification example.

In the support body 410, the bottom wall with the bottom face 411 and the sidewall with an inner peripheral face 412 are preferable to be formed in thickness considering transmissivity and transparency of the ultrasonic waves, durability, and liquid tightness.

With the configurations of the third modification example and the fourth modification example, the internal space functions as the non-wetted part where the cleaning liquid 23 does not enter when the support body 410 is immersed into the cleaning liquid 23. This makes it possible to implement the detector as a form that is capable of securely ensuring the liquid tightness with a compact and easy-to-manufacture configuration.

### Fifth and Sixth Modification Examples

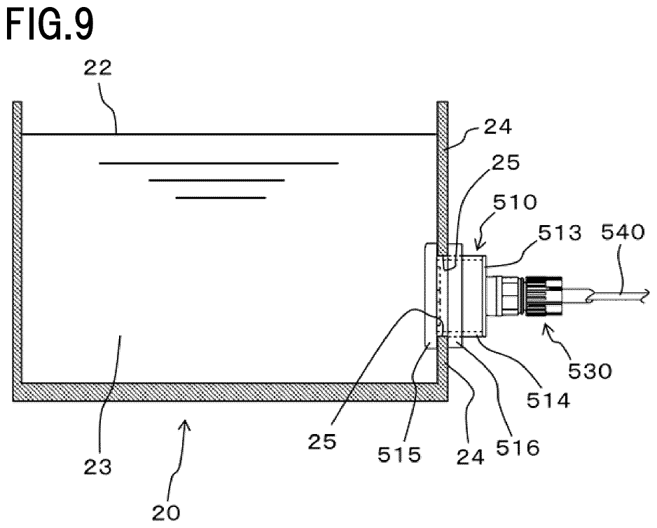

FIG. 8A is a plan view illustrating placement of a support body 510 and sound pressure sensors 521, 522, and 523 according to a fifth modification example, and FIG. 8B is a side view illustrating a configuration of a detector according to the fifth modification example. FIG. 8C is a plan view illustrating placement of the support body 510 and sound pressure sensors 551, 552, and 553 according to a sixth modification example, and FIG. 8D is a side view illustrating a configuration of a detector according to the sixth modification example. FIG. 9 is a diagram illustrating a state where the detector according to the fifth modification example is fixed to the cleaning tank 20 that is illustrated in cross section. FIGS. 8A and 8C illustrate the states where the support body 510 is closed by a lid part 513, and inside structures are illustrated with broken lines. The fifth modification example and the sixth modification example will be described by applying same reference numerals to the common members.

The support body 510 is formed with the same material as that of the first embodiment, and has a configuration in which a hollow columnar main body unit 514 and a disc part 515, which has a disc shape with a larger diameter than the main body unit 514 and closes the bottom part of the main body unit 514, are formed integrally. As for the disc part 515, the outer peripheral part thereof extends in a flange shape toward the outer side than the external peripheral face of the main body part 514 in the radial direction.

In the fifth modification example illustrated in FIGS. 8A and 8B, the three sound pressure sensors 521, 522, and 523 are adhered and fixed on a bottom face 511 on the inner side of the support body 510. Each of the sound pressure sensors 521, 522, and 523 is placed around a central axis AX5 to extend in the radial direction from a central axis AX5 side to be symmetrical with each other at equal angular intervals about the central axis AX5 of the support body 510.

After having the sound pressure sensors 521, 522, and 523 placed inside, the support body 510 has the top part sealed by the disc-shaped lid part 513. This makes it possible to prevent the liquid from entering the internal space where the sound pressure sensors are placed.

A connector 530 is placed on the lid part 513, and electrically connected to each of the sound pressure sensors 521, 522, and 523. A cable 540 connected to the main body unit 50 is connected to the connector 530. Thereby, the sound pressure sensors 521, 522, 523 and the main body unit 50 are connected to each other. The connector 530 and the cable 540 are placed concentrically with the central axis AX5, and provided in a range that is a smaller size than the support body 510 in the radial direction.

In the sixth modification example illustrated in FIGS. 8C and 8D, the three sound pressure sensors 551, 552, and 553 are adhered and fixed on an inner peripheral face 512 of the support body 510. Each of the sound pressure sensors 551, 552, and 553 is placed to extend along the central axis AX5 at positions to be symmetrical with each other at equal angular intervals about the central axis AX5 of the support body 510. The configurations regarding the lid part 513, the connector 530, and the cable 540 are the same as those of the fifth modification example.

In the support body 510, the disc part 515 with the bottom face 511 and the sidewall with the inner peripheral face 512 are preferable to be formed in thickness considering of the transmissivity and transparency ultrasonic waves, durability, and liquid tightness.

A helical groove is formed on an outer peripheral face 514a of the main body unit 514 of the support body 510. A ring-shaped nut 516 having a helical groove on the inner peripheral face thereof is screwed into the outer peripheral face 514a. The nut 516 is capable of moving in the directions along the central axis AX5 in accordance with the engagement of the helical groove on its inner peripheral face with the helical groove on the outer peripheral face 514a of the main body unit 514.

As illustrated in FIG. 9, a through fixation hole part 25 formed in a circular shape with the same diameter as that of the main body unit 514 of the support body 510 is provided on a sidewall 24 of the cleaning tank 20. The detector according to the fifth modification example is inserted from the inner side of the cleaning tank 20 into the fixation hole part 25, and the cable 540, the connector 530, and the lid part 513 side of the main body unit 514 are exposed to the outer side of the cleaning tank 20. In this state, on the outer side of the cleaning tank 20, the nut 516 is engaged with the main body unit 514 to clamp the sidewall 24 of the cleaning tank 20 with the nut 516 and the disc part 515, and the clamped part is fixed by an adhesive. This makes it possible to seal the fixation hole part 25 so as to suppress inflow and outflow of the cleaning liquid 23, while the disc part 515 is being placed inside the cleaning tank 20.

Note that such placement of the detector can also applied to the detector of the sixth modification example in the same manner.

With the configurations of the fifth modification example and the sixth modification example, the disc part 515 of the support body 510 can be immersed in the cleaning liquid 23 inside the cleaning tank 20 and securely fixed to the cleaning tank 20 by a simple configuration. Furthermore, the internal space of the support body 510 functions as the non-wetted part where the cleaning liquid 23 does not enter when the disc part 515 is immersed into the cleaning liquid 23. This makes it possible to implement the detector as a form that is capable of securely ensuring the liquid tightness with a compact and easy-to-manufacture configuration.

While the configuration with three sound pressure sensors is described in the first, third, fourth, fifth, and sixth modification examples of the first embodiment and the configuration with four sound pressure sensors is described in the second modification example, the number of sound pressure sensors is not limited thereto but two, or five or more sound pressure sensors can be placed at equal angular intervals. In a case of two sound pressure sensors, the sound pressure value of a single higher sound pressure sensor is used as the reference sound pressure value instead of the average value Ave of the sound pressure values of the two higher sound pressure sensors used in the case of the first embodiment described above. In a case of four or more sound pressure sensors, it is preferable to use the average value Ave of the sound pressure values of the two higher sound pressure sensors as the reference sound pressure value as in the case of the first embodiment. However, all the sound pressure sensors except a single lower sound pressure sensor, or three or more sound pressure sensors may be set as the higher sound pressure sensors and the average value of the sound pressure values thereof may be used as the reference sound pressure value.

While the product of the average value Ave of the sound pressure values of the higher sound pressure sensors is compared with the lowest sound pressure value Min in the first embodiment for determining whether the working state of the sound pressure sensor is normal or abnormal, the target for making a comparison with the sound pressure value Min is not limited thereto. For example, it is also possible to use values acquired by adding or subtracting a threshold instead of the threshold value X to/from the average value Ave.

While the piezoelectric elements are used as the sound pressure sensors in the first embodiment, the sound pressure sensors are not limited thereto as long as it is possible to detect the sound pressure of the cleaning liquid 23 in the cleaning tank 20. For example, diaphragms (vibration plates) may be used.

In the first embodiment, the neighboring sound pressure sensors are placed to be adjacent to each other. The close distance is set according to the size of the piezoelectric elements as the sound pressure sensors and the size of the support body 110 in the radial direction, and such close placement makes it possible to suppress variation in the sound pressure values detected in each of the sound pressure sensors to be in a specific value or less. In terms of the effect of suppressing such variation, it is preferable for the minimum distance between the neighboring sound pressure sensors to be greater than 0 and 50% or less of the width of the sound pressure sensors.

In the first embodiment, the detector 10 is placed such that the sound pressure sensors 121, 122, and 123 are exposed from the cleaning liquid 23. However, in a case where a cover or the like is provided for covering the rear end part 110b of the support body 110 to be in a watertight state without obstructing deformation of the sound pressure sensors 121, 122, and 123, the sound pressure sensors 121, 122, and 123 may also be placed at positions lower than the water surface.

### First and Second Examples

Numerical value examples 1 and 2 of the detection result regarding the ultrasonic cleaning device 100 according to the first embodiment are indicated in Table 1 and Table 2, respectively.

TABLE 1

| | | | AVERAGE | | |
|---|---|---|---|---|---|
| | | | VALUE | | |
| SOUND | SOUND | SOUND | OF TWO | | |
| PRES- | PRES- | PRES- | HIGHER | THRESH- | |
| SURE | SURE | SURE | VALUES | OLD | Ave × |
| VALUE A | VALUE B | VALUE C | Ave | X | X |
| 51 | 48 | 83 | 52 | 0.5 | 26 |

TABLE 2

| | | | AVERAGE | | |
|---|---|---|---|---|---|
| | | | VALUE | | |
| SOUND | SOUND | SOUND | OF TWO | | |
| PRES- | PRES- | PRES- | HIGHER | THRESH- | |
| SURE | SURE | SURE | VALUES | OLD | Ave × |
| VALUE A | VALUE B | VALUE C | Ave | X | X |
| 51 | 15 | 53 | 52 | 0.5 | 26 |

In the first example shown in Table 1, the sound pressure value A detected by the sound pressure sensor 121 is 51 (mV), the sound pressure value B detected by the sound pressure sensor 122 is 48 (mV), and the sound pressure value C detected by the sound pressure sensor 121 is 53 (mV). From those sound pressure values, the average value Ave of the sound pressure values of the two sound pressure sensors 121 and 123 as the higher sound pressure sensors is 52 (mV). In the meantime, the sound pressure value 48 of the sound pressure sensor 122 as the lower sound pressure sensor is the lowest sound pressure value Min. When the threshold X is 0.5, the average value Ave×X equals to 26. Thus, the sound pressure value 26 is compared with 48 that is the sound pressure value Min, and it is determined that the working state of the sound pressure sensor 122 as the lower sound pressure sensor is normal since 48 is greater.

In the second example shown in Table 2, the sound pressure value A detected by the sound pressure sensor 121 is 51 (mV), the sound pressure value B detected by the sound pressure sensor 122 is 15 (mV), and the sound pressure value C detected by the sound pressure sensor 121 is 53 (mV). From those sound pressure values, the average value Ave of the sound pressure values of the two sound pressure sensors 121 and 123 as the higher sound pressure sensors is 52 (mV). In the meantime, the sound pressure value 15 of the sound pressure sensor 122 as the lower sound pressure sensor is the lowest sound pressure value Min. When the threshold X is 0.5, the average value Ave×X equals to 26. Thus, the sound pressure value 26 is compared with 15 that is the sound pressure value Min, and it is determined that the working state of the sound pressure sensor 122 as the lower sound pressure sensor is abnormal since 15 is smaller. It is displayed on the display unit 54 that the working state is abnormal.

With the first embodiment, whether there is abnormality in any of the sound pressure sensors 121, 122, and 123 can be determined promptly with a simple configuration when there is abnormality in the working state such having small output from the sound pressure sensors 121, 122, and 123 that detect the sound pressure of the cleaning liquid 23 in the cleaning tank 20 of the ultrasonic cleaning device 100.

### Second Embodiment

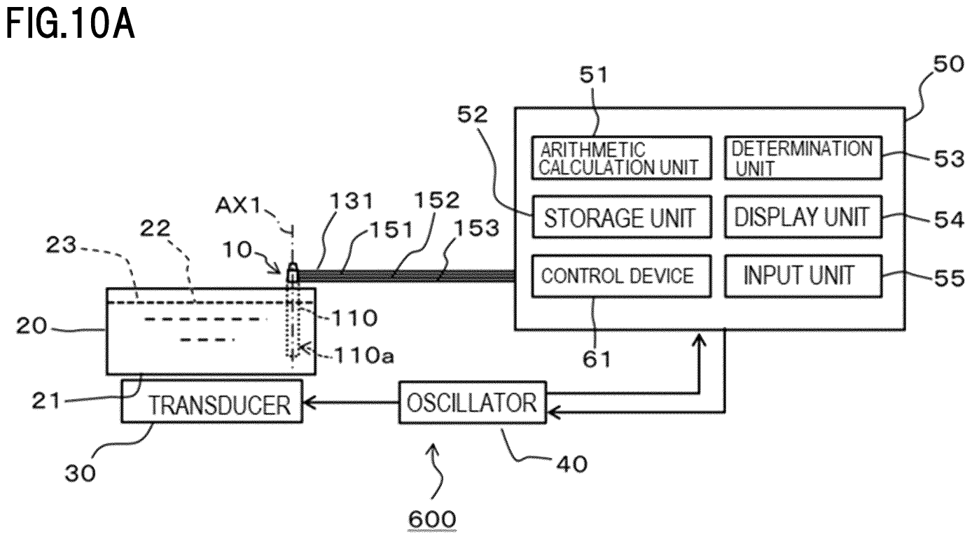

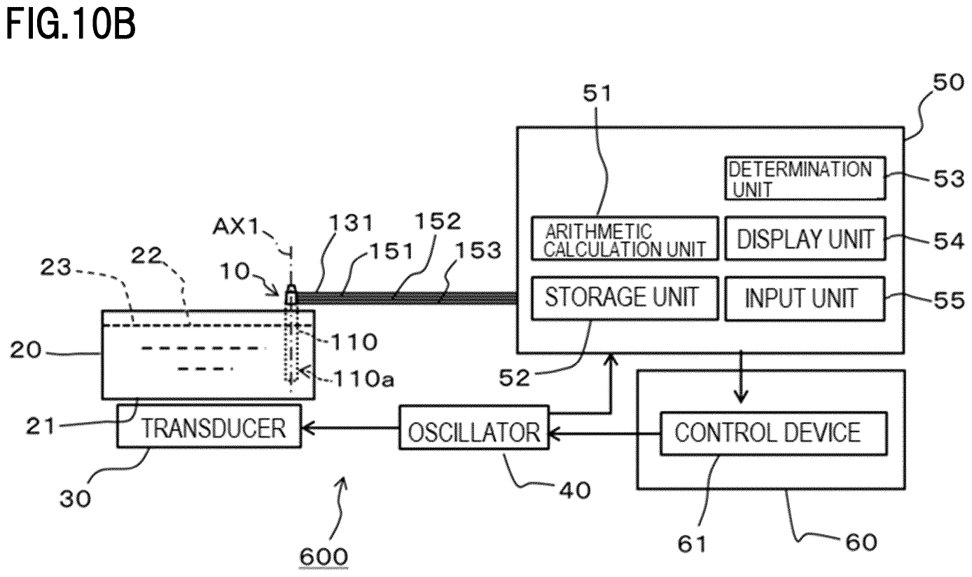

Subsequently, a second embodiment of the present invention will be described. FIGS. 10A and 10B are diagrams including block diagrams illustrating a configuration of an ultrasonic cleaning device 600 according to the second embodiment. As illustrated FIG. 10A, the same drive signals supplied from the oscillator 40 to the transducer 30 are also output to the main body unit 50 simultaneously in the ultrasonic cleaning device 600 of the second embodiment, in addition to the same configuration as that of the ultrasonic cleaning device 100 of the first embodiment. Furthermore, as illustrated in FIG. 10B, it is also possible to have a configuration in which the ultrasonic cleaning device 600 includes the external device 60 that has the same control device 61 as that of the first embodiment.

The ultrasonic cleaning device 600 is configured such that the same drive signal is simultaneously sent from the oscillator 40 to the transducer 30 and the main body unit 50. In the main body unit 50, the determination unit 53 identifies whether the drive signal from the oscillator 40 has arrived and, based on the identification result, determines whether the oscillator 40 is outputting the drive signal properly. The main body unit 50 (the determination unit 53) as the control means determines that the operation state of the ultrasonic cleaning device 600 is normal when the working states of all sound pressure sensors 121, 122, 123, the working state of the transducer 30, and the working state of the oscillator 40 are all normal, and determines that the operation state of the ultrasonic cleaning device 600 is abnormal when there is abnormality in any of the working states of each of the structural components.

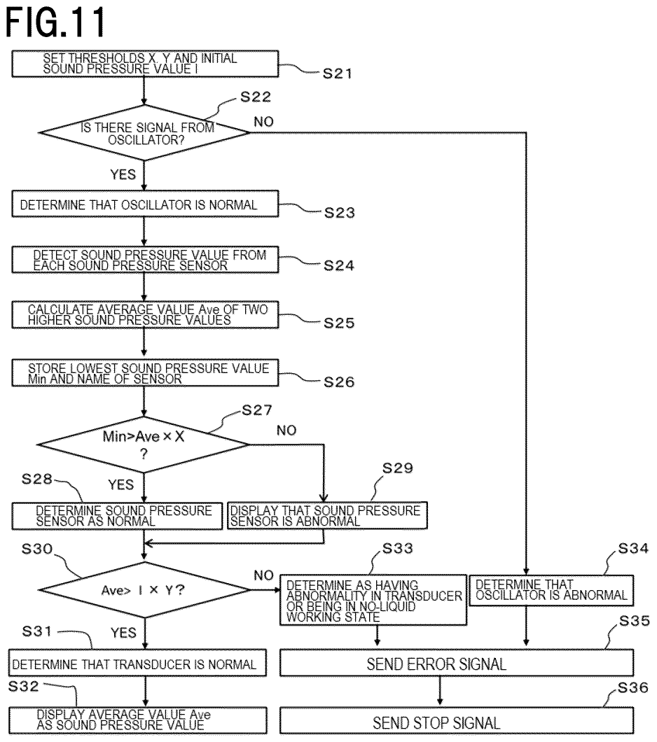

FIG. 11 is a flowchart indicating a procedure for normal/abnormal determination according to the second embodiment. Hereinafter, a flow of normal/abnormal determination according to the second embodiment will be described with reference to FIG. 11.

Before starting to drive the transducer 30, the input unit 55 is operated to set and store in advance thresholds X, Y, and an initial sound pressure value I in the storage unit 52 (step S21 in FIG. 11). The thresholds X and Y are set in the same manner as the threshold X of the first embodiment, and may be set to a same numerical value with each other. The initial sound pressure value I is the sound pressure value that is assumed to be detected when the sound pressure sensors 121, 122, and 123 properly detect the ultrasonic waves generated by the drive signals that are supplied from the oscillator 40 in a normal working state to the transducer 30 in a normal working state. Alternatively, it may be a sound pressure value that is actually detected by the sound pressure sensor known to be in a normal working state.

Then, output of the drive signals from the oscillator 40 to the transducer 30 and the main body unit 50 is started, and it is determined in the determination unit 53 whether a prescribed drive signal from the oscillator 40 has arrived (step S22).

When it is found in the determination regarding whether a prescribed drive signal has arrived from the oscillator 40 (step S22) that the drive signal has arrived (YES at step S22), the determination unit 53 determines that the oscillator 40 is working properly (step S23). When found that the drive signal has not arrived (NO at step 22), the determination unit 53 determines that there is abnormality in the working state of the oscillator 40 (step S34).

When a prescribed signal from the oscillator 40 to the main body unit 50 has arrived (YES at step S22), the drive signal is also input to the transducer 30 and the ultrasonic waves generated by the transducer 30 are irradiated to the cleaning tank 20. At this time, the sound pressure corresponding to the irradiated ultrasonic waves is generated in the cleaning tank 20. Vibration corresponding to the sound pressure occurs in the support body 110 of the detector 10 in the part immersed in the cleaning liquid 23, and the vibration is propagated to the rear end part 110b side. The vibration is converted into voltages proportional to deformation in the sound pressure sensors 121, 122, and 123 provided on the slopping faces 111, 112, and 113 of the rear end part 110b, the voltages are converted to the sound pressure values in the arithmetic calculation unit 51, and the sound pressure values in each of the sound pressure sensors 121, 122, and 123 are detected thereby (step S24). The detected sound pressure values are saved in the storage unit 52 in association with the sound pressure sensors 121, 122, and 123.

The arithmetic calculation unit 51 compares the three sound pressure values that are detected by each of the three sound pressure sensors 121, 122, and 123 at the same timing, and determines the order according to the magnitude of the sound pressure values. Furthermore, the arithmetic calculation unit 51 calculates the average value Ave (reference sound pressure value) of the two higher sound pressures (higher sound pressure values), and saves it in the storage unit 52 along with the names for specifying the corresponding sound pressure sensors (step S25). The arithmetic calculation unit 51 also saves the lowest sound pressure value Min (lower sound pressure value) in the storage unit 52 along with the name for specifying the corresponding sound pressure sensor (step S26). In the saving operations performed at steps S25 and S26 described above, the time thereof is also saved in an associated manner.

Then, the average value Ave and the lowest sound pressure value Min are supplied to the determination unit 53. The determination unit 53 reads out the threshold X to calculate the product of the average value Ave and the threshold X, and compares it with the sound pressure value Min (step S27).

When the sound pressure value Min is greater than the product of the average value Ave and the threshold X (YES at step S27), the determination unit 53 determines that the sound pressure sensor corresponding to the sound pressure value Min is in a normal working state (step S28). In the meantime, when the sound pressure value Min is smaller than or equivalent to the product of the average value Ave and the threshold X (NO at step S27), the determination unit 53 determines that the sound pressure sensor corresponding to the sound pressure Min is in an abnormal working state. When determined to be abnormal, the determination unit 53 causes the display unit 54 to display that there is abnormality in the working state of the sound pressure sensor (step S29).

Following steps S28 and S29, the determination unit 53 reads out the threshold Y and the initial sound pressure value I from the storage unit 52 and compares the product of those with the average value Ave (step S30), regardless of whether there is abnormality in the working state of the sound pressure sensor.

When the average value Ave is greater than the product of the threshold Y and the initial sound pressure value I (YES at step S30), the determination unit 53 determines that the transducer 30 is in a normal working state (step S31) and causes the display unit 54 to display the average value Ave as the sound pressure value (step S32). At this time, the main body unit 50 (the determination unit 53) as the control means determines that the operation state of the ultrasonic cleaning device 600 is normal since the working states of each of the structural components are all normal.

In the meantime, when the average value Ave is smaller than or equivalent to the product of the threshold Y and the initial sound pressure value I (NO at step S30), the determination unit 53 determines as having abnormality in the working state of the transducer 30 or being in a no-liquid working state (step S33).

Upon determining at step S33 that the working state of the transducer 30 is abnormal and determining at step S34 that the working state of the oscillator 40 is abnormal, the determination unit 53 sends an error signal to the control device 61 (step S35). Upon receiving the error signal, the control device 61 sends a stop signal to the oscillator 40 to stop sending the drive signal to the transducer 30 (step S36).

Here, the main body unit 50 as the control means determines that the operation state of the ultrasonic cleaning device 600 is abnormal, when the working state of any of the structural components is abnormal.

The threshold Y is set based on the fluctuation of the sound pressure values due to the environment and the like and the allowable range of the deterioration in the performance of the sound pressure sensors. When used for determining whether the average value Ave is greater than the product of the initial sound pressure value I and the threshold Y as performed at step S30 described above, it is preferable to be se to a numerical value that is 0.5 or more and smaller than 1. By setting the threshold Y to 0.5 or more, it becomes possible to continue stable cleaning without determining the working state of the transducer 30 as abnormal because of a slight change in the average value Ave that changes depending on the actual cleaning condition. However, the threshold changes depending on the use conditions, so that it is desirable to be set in accordance with the use environment.

### Third Example

A numerical value example of the detection result regarding the ultrasonic cleaning device 600 according to the second embodiment is indicated in Table 3.

TABLE 3

| INITIAL | | | | AVERAGE | | | | |
|---|---|---|---|---|---|---|---|---|
| SOUND | SOUND | SOUND | SOUND | VALUE OF | | | | |
| PRESSURE | PRESSURE | PRESSURE | PRESSURE | TWO HIGHER | | | | |
| VALUE | VALUE | VALUE | VALUE | VALUES | THRESHOLD | THRESHOLD | | |
| I | A | B | C | Ave | X | Y | Ave × X | I × Y |
| 55 | 21 | 21 | 19 | 21 | 0.5 | 0.6 | 10.5 | 33 |

In the third example shown in Table 3, the initial sound pressure value I is 55 (mV), the sound pressure value A detected by the sound pressure sensor 121 is 21 (mV), the sound pressure value B detected by the sound pressure sensor 122 is 21 (mV), and the sound pressure value C detected by the sound pressure sensor 121 is 19 (mV). From those sound pressure values, the average value Ave of the sound pressure values of the two sound pressure sensors 121 and 123 as the higher sound pressure sensors is 22 (mV). In the meantime, the sound pressure value 19 of the sound pressure sensor 123 as the lower sound pressure sensor is the lowest sound pressure value Min. When the threshold X is 0.5 and the threshold Y is 0.6, the average value Ave x X equals to 10.5 and the initial sound pressure value I x threshold Y equals to 33.

In such a state, under a condition where there is a signal from the oscillator 40 (YES at step S22 in FIG. 11, the working state of the oscillator 40 is normal), the determination results at steps S27 and S30 are as follows.
(1) For “Min>Ave×X?” at Step S27, it is determined that the working state of the sound pressure sensor is normal since the sound pressure value Min is greater because the sound pressure value Min is 19 and Ave×X is 10.5.
(2) For “Min>I×Y?” at Step S30, it is determined that there is abnormality in the working state of the transducer 30 since the average value Ave is smaller because the average value Ave is 21 and I×Y is 33.

In addition to the operational effects of the first embodiment, it is possible with the second embodiment to determine which of the sound pressure sensors 121, 122, 123, the transducer 30, and the oscillator 40 has an abnormal working state when there is abnormality in the output from the detector 10.

Note that the other operations, effects, and modification examples thereof are the same as those of the first embodiment.

While the present invention is descried by referring to the embodiments, the present invention is not limited to those embodiments but modifications and changes are possible for the purpose of improvement or within the spirit and scope of the present invention.

What is claimed is:

1. A detector detecting a sound pressure of a cleaning liquid in an ultrasonic cleaning device that comprises: a cleaning tank with the cleaning liquid; a transducer configured to irradiate an ultrasonic wave to the cleaning tank; and an oscillator configured to apply a drive signal to the transducer for generating the ultrasonic wave, the detector comprising:
a support body that is immersed at least partially in the cleaning liquid; and
a plurality of sound pressure sensors having a same detection characteristic with each other, the sound pressure sensors being placed in a non-wetted part of the support body at equal intervals about a central axis of the support body, wherein
vibration caused by the ultrasonic wave propagated through the support body is detected as a sound pressure value by each of the plurality of sound pressure sensors.

2. An ultrasonic cleaning device comprising:
a cleaning tank with a cleaning liquid;
a transducer configured to irradiate an ultrasonic wave to the cleaning tank;
an oscillator configured to apply a drive signal to the transducer for generating the ultrasonic wave;
a detector comprising: a support body that is immersed in the cleaning liquid at least in a tip end part; and a plurality of sound pressure sensors having a same detection characteristic with each other, the sound pressure sensors being placed in a rear end part of the support body at equal intervals about a central axis of the support body, wherein vibration caused by the ultrasonic wave propagated through the support body is detected as a sound pressure value by each of the plurality of sound pressure sensors; and
a controller where the detector is connected, wherein
the controller determines whether an operation state of the ultrasonic cleaning device is normal or abnormal based on a detection result of the detector.

3. The ultrasonic cleaning device according to claim 2, wherein
the controller comprises:
a determiner configured to determine whether a working state of the detector is normal or abnormal based on the sound pressure values detected by each of the plurality of sound pressure sensors; and
a display capable of displaying the detection result acquired by the detector, and
the determiner sets the plurality of sound pressure sensors as a single lower sound pressure sensor with the sound pressure value that is the smallest and as a higher sound pressure sensor except the lower sound pressure sensor, and determines whether the working state of the detector is normal or abnormal based on a lower sound pressure value detected by the lower sound pressure sensor and a reference sound pressure value that corresponds to a higher sound pressure value detected by the higher sound pressure sensor.

4. The ultrasonic cleaning device according to claim 3, wherein the determiner determines whether the working state of the detector is normal or abnormal based on a result of comparison between a product of the reference sound pressure value and a prescribed threshold and the lower sound pressure value.

5. The ultrasonic cleaning device according to claim 4, wherein, when there are three or more sensors as the plurality of sound pressure sensors, the reference sound pressure value is an average value of the higher sound pressure values of two higher sound pressure sensors with greater sound pressure values among the higher sound pressure sensors.

6. The ultrasonic cleaning device according to claim 5, wherein the determiner determines whether a working state of the oscillator is normal or abnormal based on whether there is output of the drive signal from the oscillator.

7. The ultrasonic cleaning device according to claim 6, wherein the determiner determines whether a working state of the transducer is normal or abnormal based on a result of comparison between an initial sound pressure value defined in advance and the reference sound pressure value.

8. The ultrasonic cleaning device according to claim 4, wherein, when there are two sensors as the plurality of sound pressure sensors, the reference sound pressure value is the higher sound pressure value that is detected by a single higher sound pressure sensor.

9. The ultrasonic cleaning device according to claim 3, comprising a controller configured to output a stop signal for stopping an operation of the ultrasonic cleaning device, when determined by the determiner that the working state of the detector is abnormal.
